(19) United States
(12) Patent Application Publication
(10) Pub. No.: US 2022/0366801 A1
(43) Pub. Date: Nov. 17, 2022

(54) INFORMATION PROCESSING DEVICE, INFORMATION PROCESSING METHOD, AND PROGRAM

(71) Applicant: SONY GROUP CORPORATION, TOKYO (JP)

(72) Inventor: KOJI ICHIKAWA, TOKYO (JP)

(21) Appl. No.: 17/753,913

(22) PCT Filed: Sep. 17, 2020
(86) PCT No.: PCT/JP2020/035276

§ 371 Date: Mar. 18, 2022

(30) Foreign Application Priority Data
Sep. 30, 2019 (JP) 2019-179112

(51) Int. Cl. G08G 5/04; G08G 5/00; B64C 39/02

(52) U.S. Cl. CPC G08G 5/045; G08G 5/0091; G08G 5/0026; G08G 5/0039; B64C 39/024

(57) ABSTRACT

The present disclosure relates to an information processing device, an information processing method, and a program capable of avoiding a collision with an obstacle more reliably.

An avoidance trajectory setting unit sets an avoidance trajectory on which a flying object can avoid a collision with an obstacle on the basis of position information of the flying object and wind speed information of a flight position represented by the position information. The technology according to the present disclosure can be applied to air traffic control devices and drones.

### TECHNICAL FIELD

The present disclosure relates to an information processing device, an information processing method, and a program, and particularly, to an information processing device, an information processing method, and a program capable of avoiding a collision with an obstacle more reliably.

### BACKGROUND ART

It is desirable to fly a drone without colliding with obstacles or people and causing harm thereto even under various geographical conditions and weather conditions.

However, a trajectory of flight can significantly change due to the influence of wind because a drone is small. Especially around buildings, wind directions and speeds are likely to change locally, and it is desirable to fly a drone while avoiding collisions even in such an environment.

On the other hand, PTL 1 discloses, for example, a technology of notifying an unmanned aerial vehicle flying around a base station equipped with an anemometer of a no-fly zone having a shape depending on a wind speed in order for the unmanned aerial vehicle to take a safer flight route.

Further, PTL 2 discloses a technology of acquiring meteorological information such as a wind speed from a meteorological information database and predicting an actual route of an unmanned aerial vehicle on the basis of a planned flight route and the meteorological information.

### CITATION LIST

### Patent Literature

### [PTL 1]

JP 2018-34691 A

### [PTL 2]

JP 2018-81675 A

### SUMMARY

### Technical Problem

However, in the above-described technologies, if a drone is away from a base station or there is a difference between meteorological information from the meteorological information database and an actual wind speed, it may not be possible to avoid a collision with an obstacle.

The present disclosure devised in view of such circumstances makes it possible to avoid a collision with an obstacle more reliably.

### Solution to Problem

An information processing device of the present disclosure is an information processing device including an avoidance trajectory setting unit configured to set an avoidance trajectory on which a flying object is able to avoid collisions with obstacles on the basis of position information of the flying object and wind speed information of a flight position represented by the position information.

An information processing method of the present disclosure is an information processing method device, using an information processing device, including setting an avoidance trajectory on which a flying object is able to avoid collisions with obstacles on the basis of position information of the flying object and wind speed information of a flight position represented by the position information.

A program of the present disclosure is a program for causing a computer to execute processing of setting an avoidance trajectory on which a flying object is able to avoid collisions with obstacles on the basis of position information of the flying object and wind speed information of a flight position represented by the position information.

In the present disclosure, an avoidance trajectory on which a flying object can avoid collisions with obstacles is set on the basis of position information of the flying object and wind speed information of a flight position represented by the position information.

### BRIEF DESCRIPTION OF DRAWINGS

FIG. 1 is a diagram illustrating an overview of an air traffic control system to which the technology according to the present disclosure is applied.

FIG. 2 is a block diagram showing an example of a hardware configuration of a drone.

FIG. 3 is a block diagram showing an example of a functional configuration of the drone.

FIG. 4 is a block diagram showing an example of a hardware configuration of an air traffic control device.

FIG. 5 is a block diagram showing an example of a functional configuration of the air traffic control device.

FIG. 6 is a diagram showing an example of an obstacle map.

FIG. 7 is a flowchart illustrating a flow of operation of the drone.

FIG. 8 is a flowchart illustrating a flow of operation of the air traffic control device.

FIG. 9 is a diagram showing an example of a possible presence area.

FIG. 10 is a diagram showing an example of a possible presence area.

FIG. 11 is a diagram showing an example of a possible presence area.

FIG. 12 is a diagram illustrating presence or absence of a possibility of collision.

FIG. 13 is a diagram illustrating presence or absence of a possibility of collision.

FIG. 14 is a diagram illustrating presence or absence of a possibility of collision.

FIG. 15 is a block diagram showing another example of the functional configuration of the drone.

FIG. 16 is a flowchart illustrating a flow of operation of the drone.

### DESCRIPTION OF EMBODIMENTS

Hereinafter, modes for carrying out the present disclosure (hereinafter referred as embodiments) will be described. The description will be made in the following order.

1. Overview of air traffic control system

2. Configuration of drone

3. Configuration of air traffic control device

4. Operation of drone

5. Operation of air traffic control device

6. Another configuration and operation of drone <1. Overview of Air Traffic Control System>

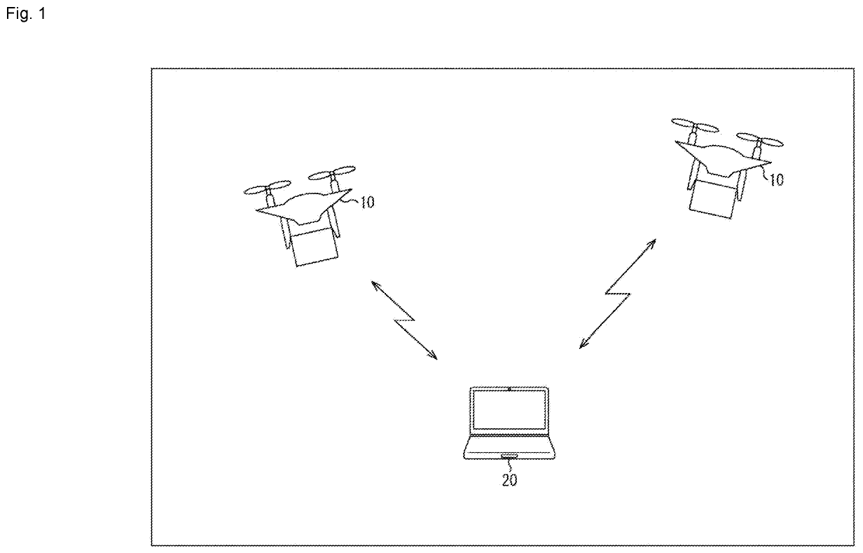

FIG. 1 is a diagram illustrating an overview of an air traffic control system to which the technology according to the present disclosure (the present technology) is applied.

In the air traffic control system of FIG. 1, a plurality of unmanned aerial vehicles (drones) 10 which are flying objects fly under the control of an air traffic control device 20 configured as an information processing device such as a personal computer (PC) or a smartphone.

The drone 10 and the air traffic control device 20 exchange information with each other through wireless communication.

For example, the drone 10 transmits position information indicating flight positions thereof and wind speed information of the flight positions to the air traffic control device 20 during flight.

The air traffic control device 20 sets an avoidance trajectory on which the drone 10 can avoid collision with obstacles on the basis of the position information and the wind speed information from the drone 10 and transmits an avoidance instruction based on the avoidance trajectory to the drone 10.

The drone 10 flies while avoiding collisions with obstacles by flying along the avoidance trajectory on the basis of the avoidance instruction from the air traffic control device 20.

<2. Configuration of Drone>

First, the configuration of the drone 10 constituting the air traffic control system of the present technology will be described.

(Hardware Configuration of Drone)

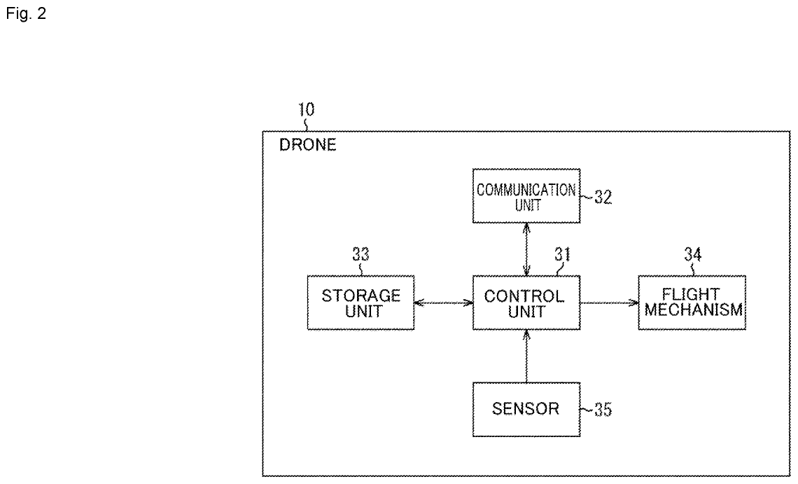

FIG. 2 is a block diagram showing an example of a hardware configuration of the drone 10.

The drone 10 includes a control unit 31, a communication unit 32, a storage unit 33, a flight mechanism 34, and a sensor 35.

The control unit 31 is composed of a processor such as a central processing unit (CPU), a memory, and the like, and controls the communication unit 32, the storage unit 33, the flight mechanism 34, and the sensor 35 by executing a predetermined program. For example, the control unit 31 controls the flight mechanism 34 on the basis of information acquired via the communication unit 32 and information stored in the storage unit 33.

The communication unit 32 is composed of a network interface or the like and performs wireless communication with the air traffic control device 20 that gives instructions to the drone 10 and any other device. For example, the communication unit 32 performs network communication with a device that is a communication partner via a base station or a repeater of Wi-Fi (registered trademark), 4G, 5G, or the like.

The storage unit 33 is composed of a non-volatile memory such as a flash memory and stores various types of information according to control of the control unit 31. For example, the storage unit 33 stores (holds) flight plans which will be described later.

The flight mechanism 34 is a mechanism for flying the drone 10 and is composed of a propeller, a motor for rotating the propeller, and the like. The flight mechanism 34 is driven according to control of the control unit 31 to fly the drone 10.

The sensor 35 is configured to include, for example, an anemometer and the like in addition to a camera, a stereo camera, and a depth sensor such as a time of flight (ToF) sensor. Further, the sensor 35 may be configured to include an inertial measurement unit (IMU) sensor and a global positioning system (GPS) sensor. Sensor data collected by the sensor 35 is used for flight control of the drone 10.

(Functional Configuration of Drone)

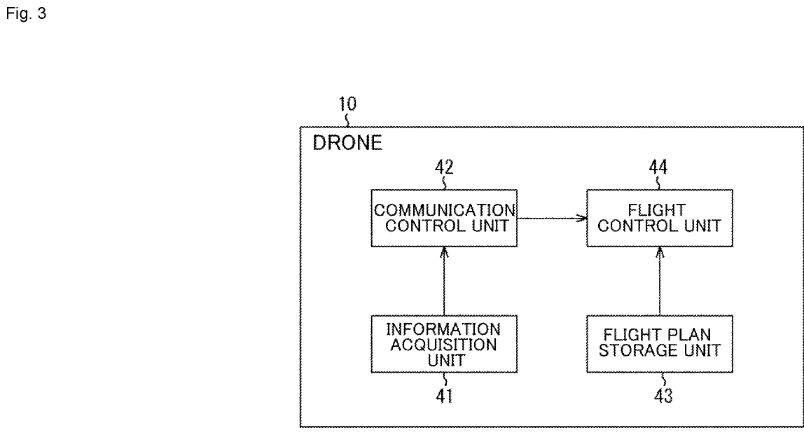

FIG. 3 is a block diagram showing an example of a functional configuration of the drone 10.

The drone 10 in FIG. 3 is composed of an information acquisition unit 41, a communication control unit 42, a flight plan storage unit 43, and a flight control unit 44.

The information acquisition unit 41 corresponds to the sensor 35 in FIG. 2, acquires position information of the drone 10 and wind speed information, and supplies the information to the communication control unit 42.

The position information includes information on the time when the position information is acquired in addition to flight positions, attitudes, and ground speeds of the drone 10. The position information may be acquired by a GPS sensor or may be acquired by estimating flight positions by an IMU sensor. Further, the position information may be acquired by estimating flight positions by simultaneous localization and mapping (SLAM) based on images acquired by a camera.

The wind speed information includes at least a direction and magnitude of a wind speed at a flight position of the drone 10. The wind speed information is acquired by an ultrasonic anemometer provided in the airframe of the drone 10 and is associated with the position information. In addition, the wind speed information may be acquired by calculating a difference between an airspeed measured by an airspeed indicator provided in the airframe and a ground speed acquired as position information. Further, the wind speed information may be acquired by obtaining a component of a force received by the airframe from an airflow from a difference between a planned flight route and a flight route along which the drone 10 actually has flown.

The communication control unit 42 transmits the position information and the wind speed information from the information acquisition unit 41 to the air traffic control device 20 by controlling the communication unit 32 of FIG. 2.

In addition, the communication control unit 42 receives an avoidance instruction transmitted from the air traffic control device 20 by controlling the communication unit 32 of FIG. 2 and supplies the avoidance instruction to the flight control unit 44.

The flight plan storage unit 43 corresponds to the storage unit 33 of FIG. 2 and stores a flight plan of the drone 10.

The flight plan includes at least a flight start point and a flight end point and may further include a waypoint that is a passing point on the way. The flight plan is created by, for example, a user designating points on a map using an application installed on a smartphone in advance and is stored in the flight plan storage unit 43.

The flight control unit 44 controls flight of the drone 10 by controlling the flight mechanism of FIG. 2.

Specifically, the flight control unit 44 controls flight of the drone 10 on the basis of the flight plan stored in the flight plan storage unit 43. In addition, when an avoidance instruction is supplied from the communication control unit 42, the flight control unit 44 controls flight of the drone 10 on the basis of an avoidance trajectory included in the avoidance instruction.

<3. Configuration of Air Traffic Control Device>

Subsequently, a configuration of the air traffic control device 20 constituting the air traffic control system of the present technology will be described.

(Hardware Configuration of Air Traffic Control Device)

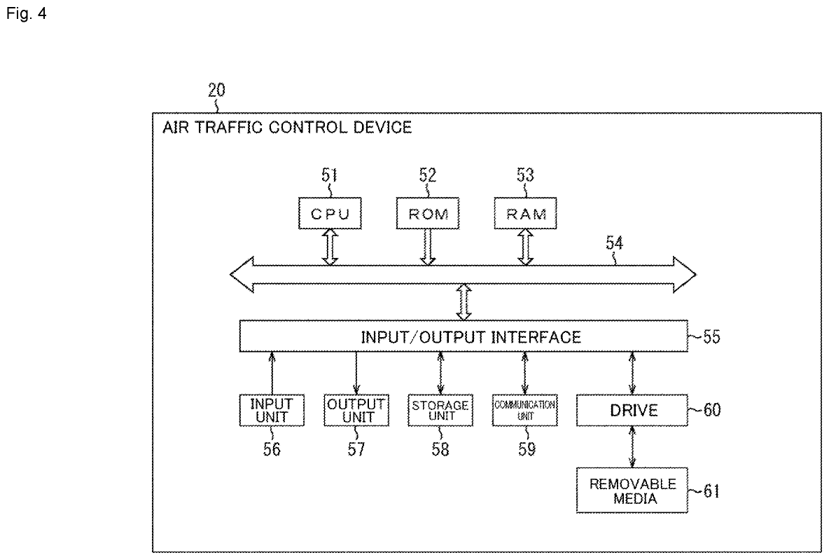

FIG. 4 is a block diagram showing an example of a hardware configuration of the air traffic control device 20.

The air traffic control device 20 includes a built-in CPU 51. An input/output interface 55 is connected to the CPU 51 via a bus 54.

When a command is input by an operator or the like operating an input unit 56 via the input/output interface 55, the CPU 51 executes a program stored in a read only memory (ROM) 52 according to the command. In addition, the CPU 51 loads a program stored in a storage unit 58 composed of a hard disk into a random access memory (RAM) 53 and executes the program.

The CPU 51 causes the air traffic control device 20 to serve as an information processing device having predetermined functions by performing various types of processing. The CPU 51 causes results of various types of processing to be output from an output unit 57, to be recorded in the storage unit 58, or to be transmitted from a communication unit 59, for example, via the input/output interface 55 as necessary.

The input unit 56 is composed of a keyboard, a mouse, a microphone, and the like. The output unit 57 is composed of an organic electroluminescence (EL) display, a liquid crystal display, a speaker, and the like. The input unit 56 may be configured as a touch panel formed integrally with a display as the output unit 57.

Programs executed by the CPU 51 can be stored in advance in the ROM 52 or the storage unit 58 as a recording medium built in the air traffic control device 20 or can be stored in removable media 61 via a drive 60.

(Functional Configuration of Air Traffic Control Device)

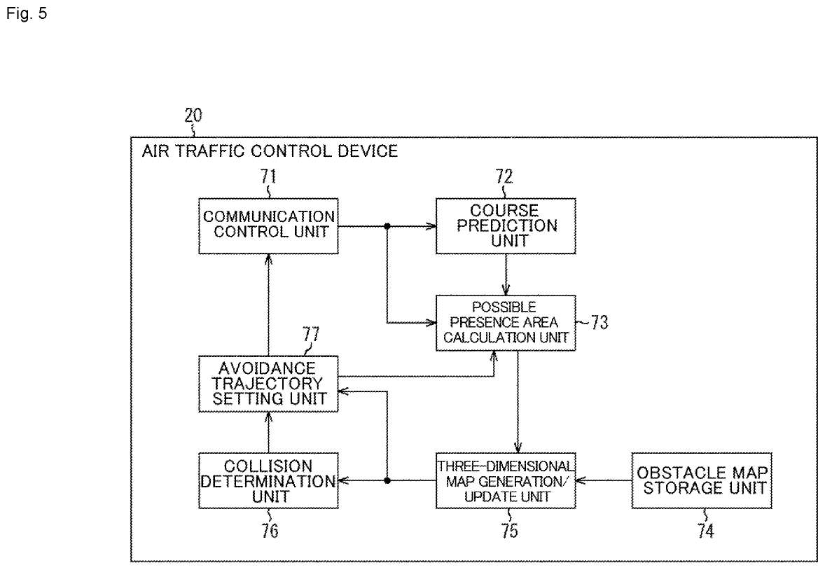

FIG. 5 is a block diagram showing an example of a functional configuration of the air traffic control device 20.

The air traffic control device 20 of FIG. 5 includes a communication control unit 71, a course prediction unit 72, a possible presence area calculation unit 73, an obstacle map storage unit 74, a three-dimensional map generation/update unit 75, a collision determination unit 76, and an avoidance trajectory setting unit 77.

At least some functional blocks shown in FIG. 5 are realized by the CPU 51 executing a predetermined program.

The communication control unit 71 receives position information and wind speed information transmitted from the drone 10 by controlling the communication unit 59 of FIG. 4. When a plurality of drones 10 are present in an airspace (controlled airspace) under the control of the air traffic control device 20, position information and wind speed information transmitted from each drone 10 are received. The received position information is supplied to the course prediction unit 72, and the received wind speed information is supplied to the possible presence area calculation unit 73.

In addition, the communication control unit 71 transmits an avoidance instruction from the avoidance trajectory setting unit 77 to the drone 10 by controlling the communication unit 59 of FIG. 4.

The course prediction unit 72 obtains a predicted position of the drone 10 after a predetermined time by predicting a course of the drone 10 using the position information from the communication control unit 71. The obtained predicted position is supplied to the possible presence area calculation unit 73.

The possible presence area calculation unit 73 calculates a possible presence area that is an area in which the drone 10 is likely to be present after a predetermined time on the basis of the predicted position from the course prediction unit 72 and the wind speed information from the communication control unit 71. When a plurality of drones 10 are present in the controlled airspace of the air traffic control device 20, possible presence areas for the plurality of drones 10 are calculated. The calculated possible presence area is supplied to the three-dimensional map generation/update unit 75.

The obstacle map storage unit 74 stores an obstacle map of the controlled airspace of the air traffic control device 20.

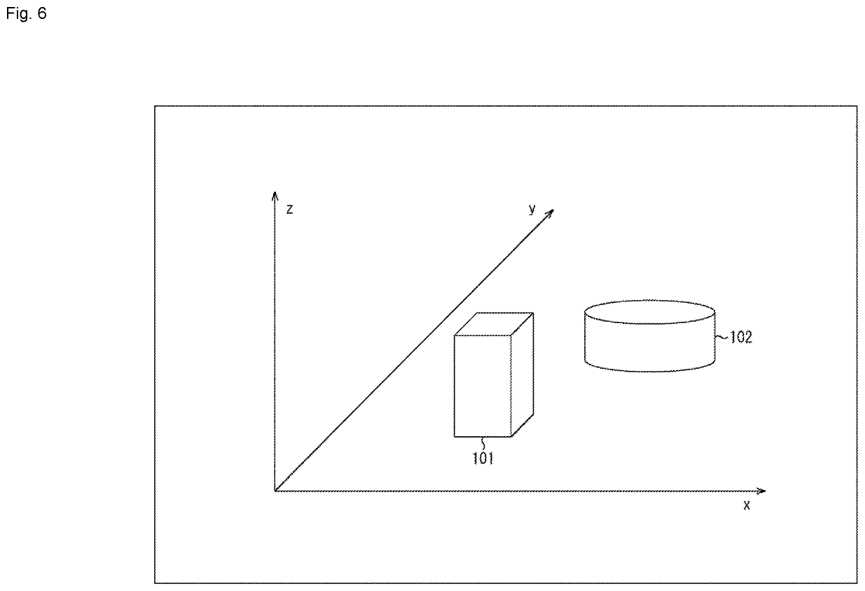

FIG. 6 is a diagram showing an example of an obstacle map.

The obstacle map of FIG. 6 includes coordinates representing the position and height of a building 101 and coordinates representing the position of a no-fly zone 102 determined by a manager of a controlled airspace as three-dimensional position information of obstacles present in the controlled airspace represented by the xyz coordinate system. The obstacle map may have the same coordinate system as the position information from the drone 10 or may be converted into the same coordinate system as the position information from the drone 10.

The obstacle map is input to the obstacle map storage unit 74 by a person in charge of operating the air traffic control system or the manager of the controlled airspace. The obstacle map is not limited thereto and may be obtained from a map information service via the Internet, for example, or constructed on the basis of satellite pictures.

Such an obstacle map is read by the three-dimensional map generation/update unit 75.

The three-dimensional map generation/update unit 75 generates a three-dimensional map that maps possible presence areas on the obstacle map on the basis of the possible presence areas from the possible presence area calculation unit 73 and the obstacle map read from the obstacle map storage unit 74. The three-dimensional map reflects possible presence areas of all drones 10 present in the controlled airspace of the air traffic control device 20. The generated three-dimensional map is supplied to the collision determination unit 76 and the avoidance trajectory setting unit 77.

The collision determination unit 76 determines presence or absence of possibility that the drone 10 in flight will collide with an obstacle or another drone 10 after a predetermined time (possibility of collision) on the basis of the three-dimensional map from the three-dimensional map generation/update unit 75. The result of determination of presence or absence of the possibility of collision is supplied to the avoidance trajectory setting unit 77.

When the collision determination unit 76 determines that there is a possibility of collision, the avoidance trajectory setting unit 77 sets an avoidance trajectory on which the drone 10 can avoid a collision with an obstacle or another drone 10 on the basis of the three-dimensional map from the three-dimensional map generation/update unit 75. The avoidance trajectory setting unit 77 supplies an avoidance instruction based on the set avoidance trajectory to the communication control unit 71.

<4. Operation of Drone>

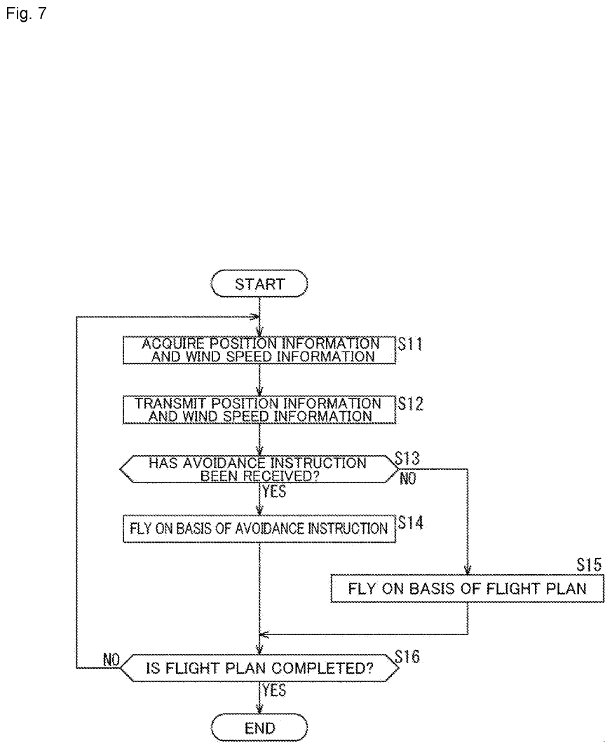

Next, a flow of operation of the drone 10 will be described with reference to the flowchart of FIG. 7.

In step S11, the information acquisition unit 41 acquires position information of the drone 10 and wind speed information. Specifically, the information acquisition unit 41 acquires the position information of the drone 10 and further acquires wind speed information of a flight position represented by the position information.

In step S12, the communication control unit 42 transmits the acquired position information and wind speed information to the air traffic control device 20. The position information and the wind speed information may be transmitted in a period predetermined by the drone 10 or the air traffic control device 20 in advance or may be transmitted at a timing requested by the air traffic control device 20. Further, current position information and wind speed information may be transmitted when there is a difference of a certain amount or more from position information and wind speed information acquired before that.

After transmission of the position information and the wind speed information, the communication control unit 42 determines whether or not an avoidance instruction has been received from the air traffic control device 20 in step S13.

When the avoidance instruction has been received from the air traffic control device 20, processing proceeds to step S14, and the flight control unit 44 controls flight of the drone 10 on the basis of the avoidance trajectory included in the avoidance instruction from the air traffic control device 20.

On the other hand, if it is determined that the avoidance instruction has not been received from the air traffic control device 20, processing proceeds to step S15, and the flight control unit 44 controls flight of the drone 10 on the basis of a flight plan stored in the flight plan storage unit 43. For example, flight of the drone 10 is controlled such that the drone 10 flies at a cruising speed determined in the airframe in a direction in which a route from the current position to the next waypoint or a flight end point is shortest.

After step S14 or step S15, the flight control unit 44 determines whether or not the flight plan is completed in step S16. Here, when the current position corresponds to the flight end point of the flight plan, it is determined that the flight plan is completed.

If the flight plan is not completed, processing returns to step S11 and subsequent processing is repeated.

On the other hand, if the flight plan is completed, the flight control unit 44 ends flight of the drone 10.

<5. Operation of Air Traffic Control Device>

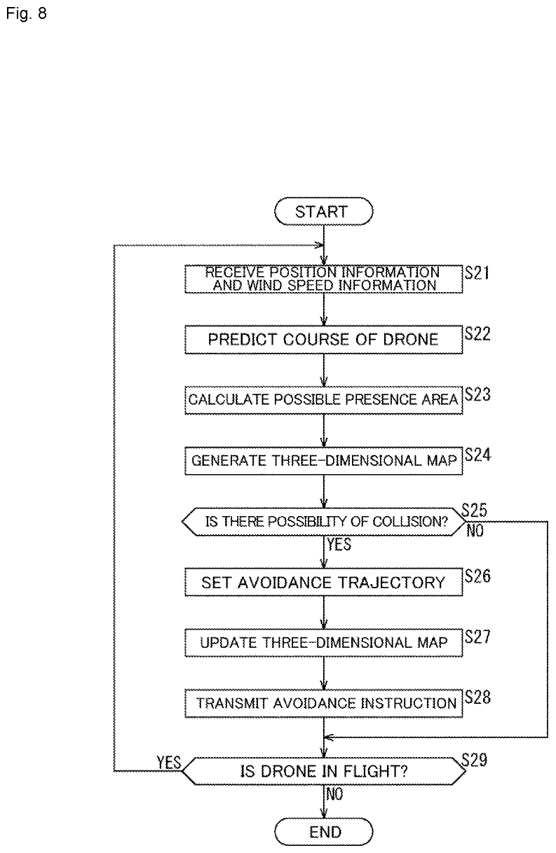

Next, a flow of operation of the air traffic control device 20 will be described with reference to the flowchart of FIG. 8.

In step S21, the communication control unit 71 receives position information and wind speed information transmitted from the drone 10 present in a controlled airspace.

Here, it is assumed that at least one drone 10 is flying in the controlled airspace. That is, two or more drones 10 may be flying in the controlled airspace.

In addition, the communication control unit 71 does not have to always receive position information and wind speed information from all drones 10 present in the controlled airspace. For example, when position information and wind speed information from a certain drone 10 are received at a certain time, it is not always necessary to receive position information and wind speed information from the drone 10 at the next time.

The communication control unit 71 may receive at least the position information between the position information and the wind speed information from the drone 10. For example, when there is a predetermined device capable of acquiring wind speed information in the controlled airspace with a fine mesh, the communication control unit 71 may receive only the position information from the drone 10 present in the controlled airspace and receive wind speed information of a flight position represented by the received position information from the predetermined device.

In step S22, the course prediction unit 72 predicts a course of the drone 10 that has transmitted the position information on the basis of the received position information. Specifically, on the basis of a flight position and time information represented by latest position information transmitted from the drone 10 which is a target of course prediction, an arrival point of the drone 10 which is moving with a current velocity vector v at a future time t is obtained as a predicted position.

In step S23, the possible presence area calculation unit 73 calculates a possible presence area of the drone 10 present in the controlled airspace on the basis of the predicted position obtained by the course prediction unit 72 and the received wind speed information. When a plurality of drones 10 are present in the controlled airspace, possible presence areas for the plurality of drones 10 are calculated.

Here, the details of the calculation of the possible presence area will be explained.

The possible presence area is an area which the drone 10 which is a flying object may reach after a predetermined time when it moves from a certain point at a certain speed. The possible presence area is calculated according to an error in position information acquisition, an error in flight control, and the wind speed information.

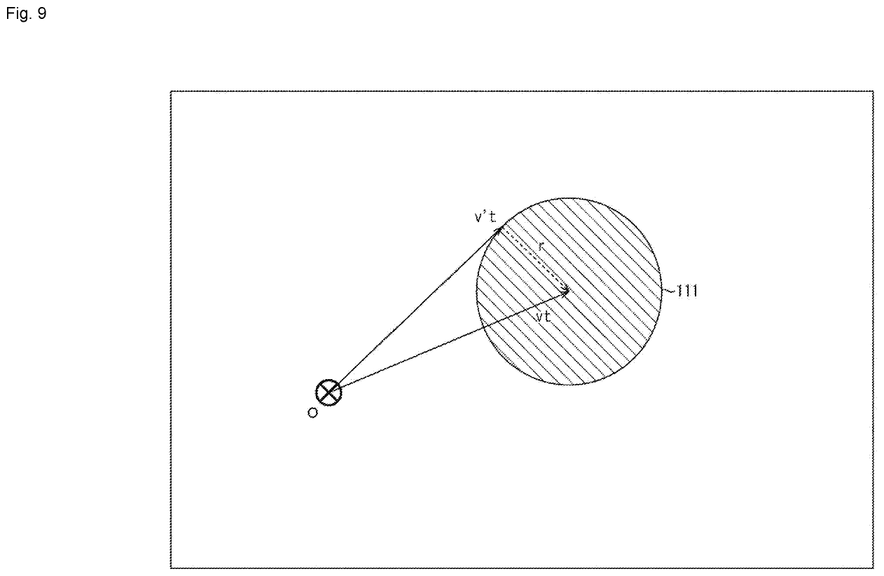

Calculation of a possible presence area for a flying object, which is flying with a velocity vector v at a current point O, at a future time t will be described with reference to FIG. 9.

The possible presence area at the time t is within a range represented by r=|vt−v′t|, where v′ is a composite vector of a maximum error vector of flight control and the velocity vector v, that is, an obliquely hatched circular area 111 where a point p represented by following formula (1) can exist.

[Math. 1]

|vt−p|≤r (1)

The error vector constituting the composite vector v′ is obtained, for example, from airframe design information of the flying object or from an average value of flight control deviations in past flights, or the like.

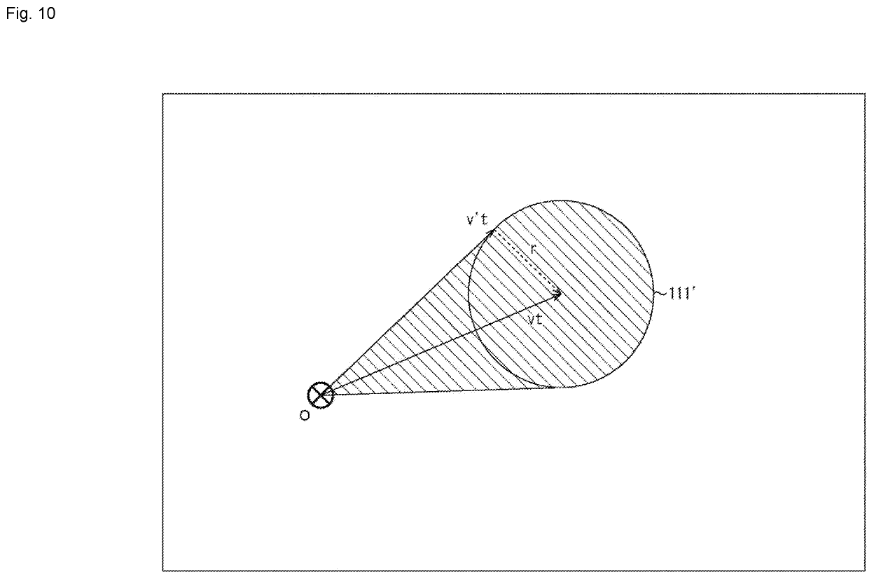

In addition, as shown in FIG. 10, the possible presence area at the time t may be an obliquely hatched area 111′ where the point p can exist when t in the aforementioned formula (1) is set to t′ (0≤t′≤t) and time t′ has been changed from 0 to t.

Furthermore, the possible presence area is extended according to a direction of the wind speed, and an enlargement ratio of the possible presence area is changed according to the magnitude of the wind speed.

For example, when the enlargement ratio of the possible presence area when the wind speed is 0 m is one time, the enlargement ratio of the possible presence area is linearly increased by 0.1 times in the same direction as the direction of the wind speed every time the observed wind speed increases by 1 m/s.

Here, it is assumed that the wind speed W is expressed by the following formula (2) and the velocity vector v of the drone 10 is represented by the following formula (3).

$$\begin{matrix}[ Math . 2 ] & \\ W = [ \begin{matrix}{W}_{x} \\ {W}_{y} \\ {W}_{z}\end{matrix} ] & ( 2 )\end{matrix}$$

$$\begin{matrix}[ Math . 3 ] & \\ v = [ \begin{matrix}{v}_{x} \\ {v}_{y} \\ {v}_{z}\end{matrix} ] & ( 3 )\end{matrix}$$

At this time, the possible presence area is transformed by, for example, affine transformation according to a matrix T represented by the following formula (4).

$$\begin{matrix}[ Math . 4 ] & \\ T = [ \begin{matrix}\frac{{W}_{x}}{\vert {W}_{x} \vert} ( 1 + \vert \frac{{W}_{x}}{10} \vert ) & 0 & 0 & {v}_{x} t ( 1 - \frac{{W}_{x}}{\vert {W}_{x} \vert} ( 1 + \vert \frac{{W}_{x}}{10} \vert ) ) \\ 0 & \frac{{W}_{y}}{\vert {W}_{y} \vert} ( 1 + \vert \frac{{W}_{y}}{10} \vert ) & 0 & {v}_{y} t ( 1 - \frac{{W}_{y}}{\vert {W}_{y} \vert} ( 1 + \vert \frac{{W}_{y}}{10} \vert ) ) \\ 0 & 0 & \frac{{W}_{z}}{\vert {W}_{z} \vert} ( 1 + \vert \frac{{W}_{z}}{10} \vert ) & {v}_{z} t ( 1 - \frac{{W}_{z}}{\vert {W}_{z} \vert} ( 1 + \vert \frac{{W}_{z}}{10} \vert ) ) \\ 0 & 0 & 0 & 1\end{matrix} ] & ( 4 )\end{matrix}$$

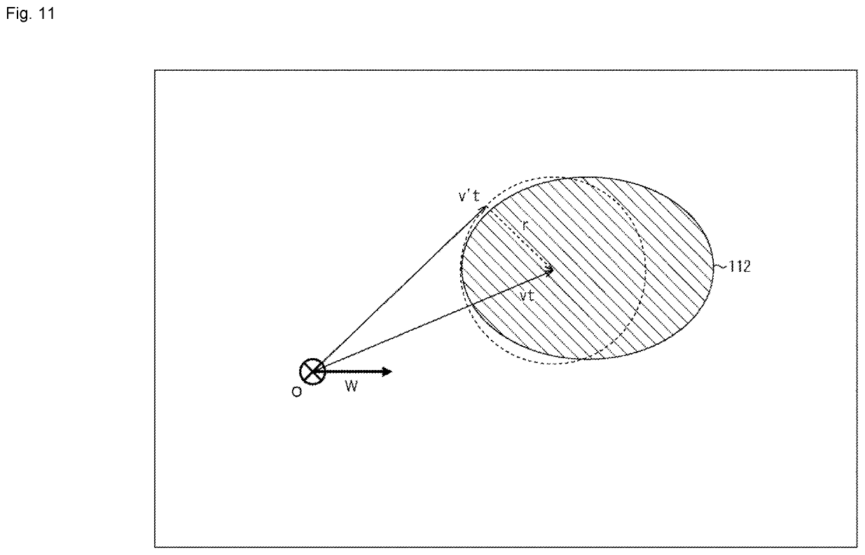

Accordingly, for example, the possible presence area represented by the circular area 111 of FIG. 9 is transformed into an elliptical area 112 extended from the circular area 111 in the direction of the wind speed W (to the right in the figure) at a predetermined enlargement ratio, as shown in FIG. 11.

In addition to the above-described method, the possible presence area may be extended in the direction of the wind speed according to the magnitude of change in the wind speed.

Referring back to the flowchart of FIG. 8, processing proceeds to step S24 upon calculation of the possible presence area.

In step S24, the three-dimensional map generation/update unit 75 reads the obstacle map from the obstacle map storage unit 74 and maps the possible presence area of the drone 10 present in the controlled airspace on the obstacle map to generate a three-dimensional map at the time t.

The three-dimensional map at the time t is generated by updating a three-dimensional map generated at a time t-1. That is, if new position information and wind speed information are not received from the drone 10 after the time t-1 with respect to the drone 10 for which the possible presence area at the time t-1 has been calculated, the possible presence area at the time t is calculated using information at the time of calculating the possible presence area at the time t-1 and mapped on the three-dimensional map at the time t.

In step S25, the collision determination unit 76 determines whether or not there is a possibility of collision of the drone 10 present in the controlled airspace at the time t on the basis of the three-dimensional map from the three-dimensional map generation/update unit 75.

Specifically, it is determined whether or not obstacles (buildings and no-fly zones) included in the obstacle map are present within the possible presence area of the drone 10 in flight at the time t in the three-dimensional map generated by the three-dimensional map generation/update unit 75.

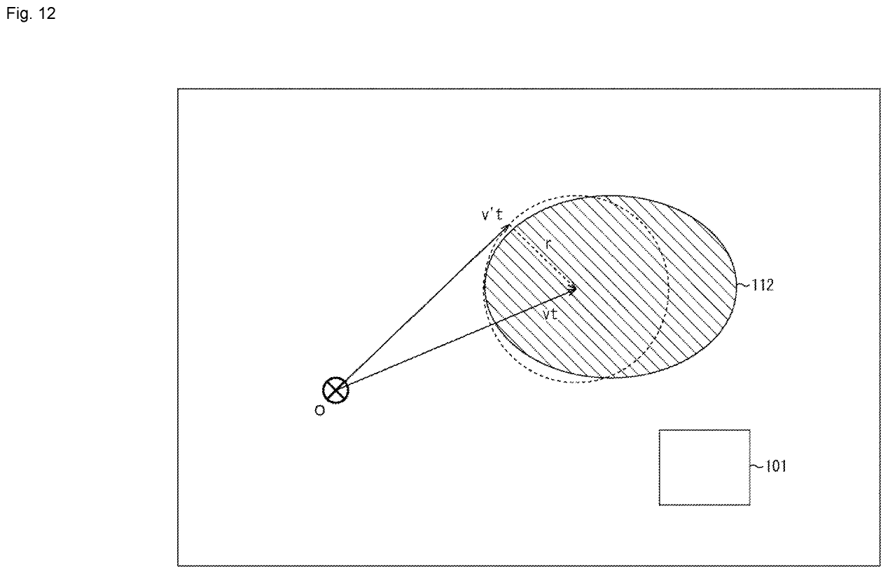

For example, as shown in FIG. 12, if the building 101 exists on the three-dimensional map but the building 101 does not exist in the elliptical area 112 calculated as a possible presence area, it is determined that there is no possibility of collision.

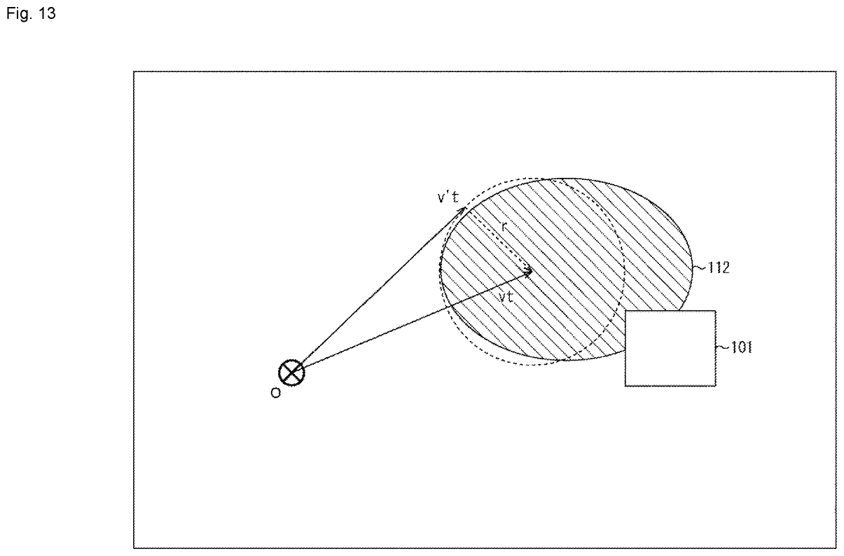

In addition, as shown in FIG. 13, if the building 101 exists on the three-dimensional map and at least a part of the building 101 exists in the elliptical area 112 calculated as a possible presence area, it is determined that there is a possibility of collision.

In addition to determining that there is a possibility of collision when an obstacle exists in a possible presence area, it may be determined that there is a possibility of collision in a case where a distance between the end of the possible presence area and an obstacle is less than a distance set in advance, and the like.

Here, a possibility of collision between drones 10 is also determined.

Specifically, when possible presence areas of a plurality of drones 10 are included in the three-dimensional map, if the possible presence area of one drone 10 overlaps with the possible presence area of another drone 10, it is determined that there is a possibility of collision for each drone 10.

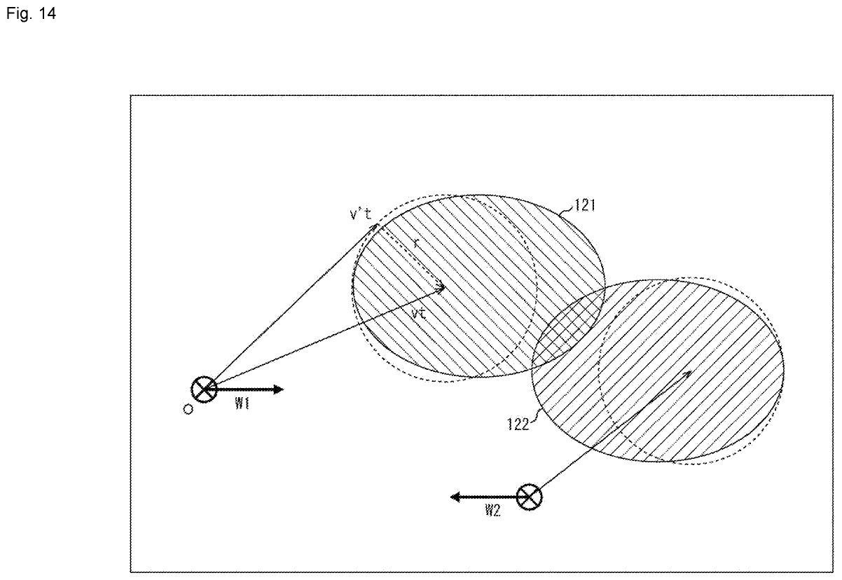

For example, as shown in FIG. 14, it is assumed that a possible presence area 121 of a first flying object calculated on the basis of the direction and magnitude of a wind speed W1 and a possible presence area 122 of a first flying object calculated on the basis of the direction and magnitude of a wind speed W2 are include in the three-dimensional map.

The wind speed W1 and the wind speed W2 have directions opposite to each other, for example, due to a so-called building wind generated in a narrow area around a large-scale building.

In the example of FIG. 14, it is determined that there is a possibility of collision between the first and second flying objects because the possible presence area 121 and the possible presence area 122 overlap.

In addition to determining that there is a possibility of collision when possible presence areas of the drones 10 overlap, it may be determined that there is a possibility of collision when a distance between one possible presence area and the other possible presence area is less than a distance set in advance.

If it is determined that there is a possibility of collision with respect to the predetermined drone 10 in step S25, processing proceeds to step S26.

In step S26, the avoidance trajectory setting unit 77 sets an avoidance trajectory of the drone 10 determined to have a possibility of collision on the basis of the three-dimensional map. When there are a plurality of drones 10 determined to have a possibility of collision, avoidance trajectories are set for the plurality of drones 10.

Specifically, a flight route for changing the traveling direction and speed of the drone 10 determined to have a possibility of collision is set.

For example, a flight route for changing a traveling direction up to a time t by 10 degrees clockwise is set on the basis of the current traveling direction of the drone 10. In addition, with respect to a drone 10 determined to have a possibility of collision with another drone 10, a flight route for changing the speed is set in addition to the traveling direction up to the time t.

After the flight route is set in this manner, a possibility of collision with respect to the drone 10 is determined again.

By repeating such processing until it is determined that there is no possibility of collision, an avoidance trajectory of the drone 10 determined to have a possibility of collision is set.

As an avoidance trajectory, a flight route for changing the traveling direction and speed within a range available for the drone 10 may be set on the basis of airframe information provided by the drone 10. In addition, a person in charge of operating the air traffic control system or a manager of the controlled airspace may set a plurality of change patterns of a traveling direction and a speed in advance, and flight routes may be sequentially selected from the change patterns to set an avoidance trajectory.

When the avoidance trajectory is set as described above, the three-dimensional map generation/update unit 75 updates the three-dimensional map on the basis of the set avoidance trajectory in step S27. Specifically, the possible presence area calculation unit 73 recalculates a possible presence area on the basis of the set avoidance trajectory and the three-dimensional map generation/update unit 75 updates the three-dimensional map on the basis of the recalculated possible presence area.

In step S28, the communication control unit 71 transmits an avoidance instruction based on the set avoidance trajectory to the drone 10. When there are a plurality of drones 10 determined to have a possibility of collision, avoidance instructions based on avoidance trajectories set for the plurality of drones 10 are respectively transmitted to the plurality of drones 10. Thereafter, processing proceeds to step S29.

On the other hand, if it is determined in step S25 that there is no possibility of collision with respect to the predetermined drone 10, steps S26 to S28 are skipped and processing proceeds to step S29.

In step S29, the air traffic control device 20 determines whether or not the drone 10 is in flight in the controlled airspace. The fact that the drone 10 is not in flight is determined by receiving information indicating the end of flight from the drone 10 or not receiving position information and wind speed information for a predetermined time or longer.

If it is determined in step S29 that the drone 10 is in flight, processing returns to step S21 and subsequent processing is repeated.

On the other hand, if it is determined in step S29 that the drone 10 is not in flight, processing ends.

According to the above processing, even if the drone present in the controlled airspace of the air traffic control device deviates from a flight longitude of a flight plan due to the influence of the wind, it is possible to prevent unintended approach to obstacles such as buildings and no-fly zones, and other drones.

In particular, even in an environment in which wind conditions are locally different, it is possible to determine the influence of wind conditions on flight of the drone with accuracy as compared to a configuration in which no-fly zones are notified on the basis of measured values of an anemometer included in a fixed base station.

In this manner, the drone can avoid collisions with obstacles and other drones more reliably even in an airspace where there is a possibility of collision and it is difficult for the drone to fly

In the above-described processing, an avoidance trajectory of the drone 10 determined to have a possibility of collision may be set on the basis of flight plans of all drones 10 present in the controlled airspace. In this case, the flight plans of all the drones 10 present in the controlled airspace may be updated at once regardless of the possibility of collision, and may be transmitted to the respective drones 10 as avoidance instructions, for example.

<6. Another Configuration and Operation of Drone>

In the air traffic control system, an example in which the drone 10 flies while avoiding collisions with obstacles or other drones 10 by setting an avoidance trajectory by the air traffic control device 20 has been described above.

In the following, an example in which the drone 10 itself sets an avoidance trajectory to fly while avoiding collisions with obstacles will be described.

(Functional Configuration of Drone)

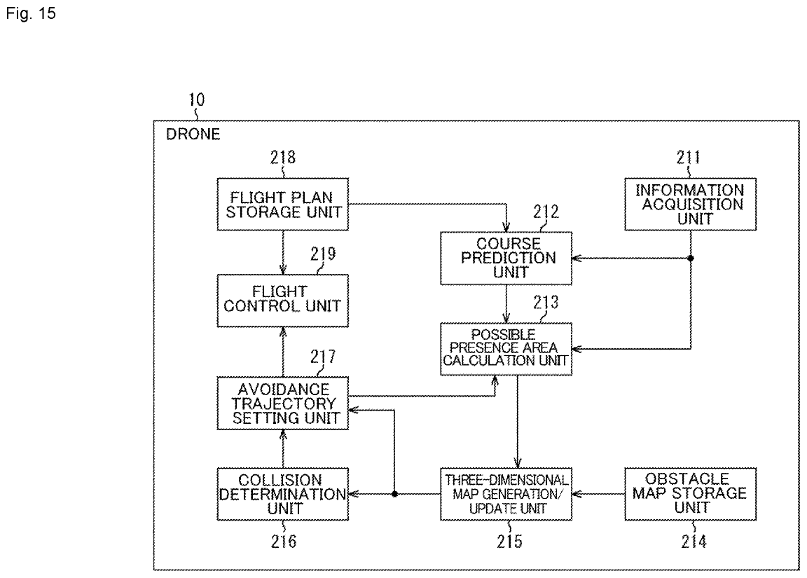

FIG. 15 is a block diagram showing another example of the functional configuration of the drone 10.

The drone 10 of FIG. 15 includes an information acquisition unit 211, a course prediction unit 212, a possible presence area calculation unit 213, an obstacle map storage unit 214, a three-dimensional map generation/update unit 215, a collision determination unit 216, and an avoidance trajectory setting unit 217, a flight plan storage unit 218, and a flight control unit 219.

The information acquisition unit 211, the flight plan storage unit 218, and the flight control unit 219 of the drone 10 of FIG. 15 have basically the same functions as those of the information acquisition unit 41, the flight plan storage unit 43, and the flight control unit 44 of the drone 10 of FIG. 3, respectively.

Further, the course prediction unit 212, the possible presence area calculation unit 213, the obstacle map storage unit 214, the three-dimensional map generation/update unit 215, the collision determination unit 216, and the avoidance trajectory setting unit 217 in the drone 10 of FIG. 15 have basically the same functions as those of the course prediction unit 72, the possible presence area calculation unit 73, the obstacle map storage unit 74, the three-dimensional map generation/update unit 75, the collision determination unit 76, and the avoidance trajectory setting unit 77 in the air traffic control device 20 of FIG. 5, respectively.

(Flow of Operation of Drone)

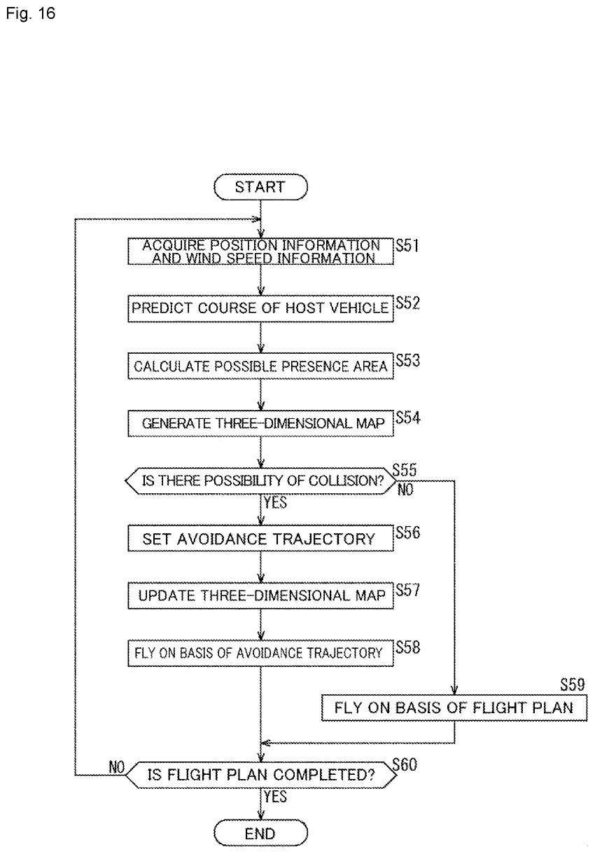

Next, a flow of operation of the drone 10 of FIG. 15 will be described with reference to the flowchart of FIG. 16.

In step S51, the information acquisition unit 211 acquires position information and wind speed information of the drone 10 (host vehicle).

In step S52, the course prediction unit 212 predicts a course of the host vehicle on the basis of the acquired position information.

Unlike the course prediction unit 72 that predicts courses of a plurality of drones 10, the course prediction unit 212 obtains a predicted position of the host vehicle after a predetermined time by predicting only the course of the host vehicle. In addition to predicting the course using the position information of the host vehicle, the course prediction unit 212 may use a flight route included in flight plans stored in the flight plan storage unit 218 as a predicted course.

In step S53, the possible presence area calculation unit 213 calculates a possible presence area on the basis of the predicted position obtained by the course prediction unit 212 and the acquired wind speed information.

The possible presence area calculation unit 213 calculates only the possible presence area of the host vehicle, unlike the possible presence area calculation unit 73 that calculates possible presence areas for a plurality of drones 10.

In step S54, the three-dimensional map generation/update unit 215 reads an obstacle map from the obstacle map storage unit 214 and generates a three-dimensional map that maps the possible presence area of the host vehicle on the obstacle map.

The obstacle map stored in the obstacle map storage unit 214 may be acquired from a map information service before the start of flight or may be acquired by communicating with a wireless base station during flight. Further, an obstacle map may be acquired on the basis of a depth sensor provided in the drone 10.

If the wind speed increases above a certain level, it may not be possible to obtain an accurate depth value from the depth sensor due to large fluctuation in the airframe. In this case, the reliability of the obstacle map acquired on the basis of the depth sensor may be lowered.

Further, when the obstacle map is acquired during flight, the obstacle map for only a predetermined range in the traveling direction of the drone 10 may be acquired.

In step S55, the collision determination unit 216 determines whether or not there is a possibility of collision of the host vehicle with an obstacle on the basis of the three-dimensional map from the three-dimensional map generation/update unit 215.

If it is determined in step S55 that there is a possibility of collision, processing proceeds to step S56, and the avoidance trajectory setting unit 77 sets an avoidance trajectory of the host vehicle on the basis of the three-dimensional map.

Although the avoidance trajectory setting unit 217 basically has the same function as the avoidance trajectory setting unit 77, if the obstacle map storage unit 214 stores an obstacle map for only a predetermined range in the traveling direction of the drone 10, the avoidance trajectory setting unit 217 sets an avoidance trajectory limited to the range.

In step S57, the three-dimensional map generation/update unit 215 updates the three-dimensional map on the basis of the set avoidance trajectory. Specifically, the possible presence area calculation unit 213 calculates a possible presence area on the basis of the set avoidance trajectory, and the three-dimensional map generation/update unit 215 updates the three-dimensional map on the basis of the calculated possible presence area.

In step S58, the flight control unit 219 controls flight of the drone 10 on the basis of the set avoidance trajectory.

On the other hand, if it is determined in step S55 that there is no possibility of collision, processing proceeds to step S59, and the flight control unit 219 controls flight of the drone 10 on the basis of a flight plan stored in the flight plan storage unit 218.

After step S58 or step S59, the flight control unit 219 determines whether or not the flight plan is completed in step S60.

If the flight plan is not completed, processing returns to step S51 and subsequent processing is repeated.

On the other hand, when the flight plan is completed, the flight control unit 219 ends flight of the drone 10 and processing ends.

According to the above processing, even when there is no air traffic control device or communication with the air traffic control device cannot be performed in an airspace where there is a possibility of collision and it is difficult for a drone to fly in general, the drone can avoid collisions with obstacle more reliably.

Meanwhile, since possible presence areas of other drones are not acquired in the configuration of FIG. 15, it is not possible to avoid collisions with other drones.

Therefore, presence or absence of a possibility of collision may be determined using results of object detection using a depth sensor, for example. Accordingly, even when possible presence areas of other drones are not acquired, it is possible to avoid collisions with other drones and also possible to avoid a collision with a fuselage other than drones.

The series of processing described above can be executed by hardware or software. In the case where the series of processing is executed by software, a program that configures the software is installed on a computer. Here, the computer includes, for example, a computer built into dedicated hardware, a general-purpose personal computer on which various programs are installed to be able to execute various functions, and the like.

In the drone 10 described above, the above-described series of processing is performed by the control unit 31 loading and executing a program stored in the storage unit 33. Further, in the air traffic control device 20, the above-described series of processing is performed by the CPU 51 loading and executing a program stored in the ROM 52 and the storage unit 58.

The program executed by the computer (the control unit 31 and the CPU 51) can be recorded and provided on removable media such as package media, for example. The program can be supplied via a wired or wireless transfer medium such as a local area network, the Internet, or digital satellite broadcasting.

In the computer, the program can be installed in the storage unit 33, the ROM 52, and the storage unit 58 by setting a removable medium in a drive. Further, the program can be installed in the storage unit 33, the ROM 52, or the storage unit 58 via a wired or wireless transmission medium.

The program executed by the computer may be a program that is processed in chronological order according to the order described in the present specification or may be a program that is processed in parallel or at a necessary timing such as when a call is made.

In the present specification, a step of describing a program to be recorded on a recording medium includes not only processing performed in chronological order in the described order but also processing executed in parallel or individually without being necessarily performed in chronological order.

The embodiments of the technology according to the present disclosure are not limited to the above-described embodiments, and various modifications can be made without departing from the gist of the technology according to the present disclosure.

The effects described in the present description are merely illustrative and not restrictive, and other effects may be obtained.

Further, the technology according to the present disclosure can take the following configuration.

(1)

An information processing device including an avoidance trajectory setting unit configured to set an avoidance trajectory on which a flying object is able to avoid a collision with an obstacle on the basis of position information of the flying object and wind speed information of a flight position represented by the position information.

(2)

The information processing device according to (1), further including a communication control unit configured to transmit an avoidance instruction based on the set avoidance trajectory to the flying object.

(3)

The information processing device according to (2), wherein the avoidance trajectory setting unit sets avoidance trajectories for a plurality of flying objects on the basis of the position information and the wind speed information of the plurality of the flying objects, and

wherein the communication control unit transmits avoidance instructions based on the avoidance trajectories set for the plurality of the flying objects to the respective plurality of flying objects.

(4)

The information processing device according to (3), wherein the avoidance trajectory setting unit sets the avoidance trajectory on which a first flying object is able to avoid collisions with an obstacle and a second flying object.

(5)

The information processing device according to any one of (2) to (4), wherein the communication control unit receives at least the position information of the position information and the wind speed information from the flying object.

(6)

The information processing device according to (5), wherein the communication control unit receives the position information and the wind speed information acquired by the flying object from the flying object.

(7)

The information processing device according to (5), wherein the communication control unit receives, from a predetermined device, the wind speed information of the flight position represented by the position information acquired by the flying object.

(8)

The information processing device according to (1), further including an information acquisition unit configured to acquire the position information and the wind speed information, and

a flight control unit configured to control flight of the flying object on the basis of the set avoidance trajectory.

(9)

The information processing device according to any one of (1) to (8), further including a collision determination unit configured to determine presence or absence of a collision with the obstacle on the basis of the position information and the wind speed information,

wherein the avoidance trajectory setting unit sets the avoidance trajectory when it is determined that there is a possibility of collision.

(10)

The information processing device according to (9), further including an area calculation unit configured to calculate a possible presence area of the flying object after a predetermined time on the basis of a predicted position of the flying object after a predetermined time predicted using the position information and the wind speed information,

wherein the collision determination unit determines presence or absence of the possibility of collision after the predetermined time on the basis of the possible presence area.

(11)

The information processing device according to (10), wherein the area calculation unit calculates the possible presence area by transforming an area based on the predicted position according to a direction and a magnitude of a wind speed represented by the wind speed information.

(12)

The information processing device according to (11), wherein the area calculation unit transforms a circular area having the predicted position as a center according to the direction and the magnitude of the wind speed represented by the wind speed information.

(13)

The information processing device according to any one of (10) to (12), wherein the area calculation unit calculates possible presence areas of the plurality of the flying objects on the basis of predicted positions of the plurality of the flying objects and the wind speed information, and

the collision determination unit further determines presence or absence of the possibility of collision between the flying objects on the basis of the possible presence areas of the plurality of the flying objects.

(14)

The information processing device according to any one of (10) to (13), further including a map generation unit configured to generate a three-dimensional map that maps the possible presence area on an obstacle map including three-dimensional position information of the obstacle,

wherein the collision determination unit determines presence or absence of the possibility of collision after the predetermined time on the basis of the three-dimensional map.

(15)

The information processing device according to (14), wherein the area calculation unit recalculates the possible presence area on the basis of the set avoidance trajectory, and

the map generation unit updates the three-dimensional map on the basis of the recalculated possible presence area.

(16)

The information processing device according to any one of (9) to (15), wherein the avoidance trajectory setting unit sets, as the avoidance trajectory, a flight route for changing at least a traveling direction of the flying object determined to have a possibility of collision.

(17)

The information processing device according to (16), wherein the avoidance trajectory setting unit sets, as the avoidance trajectory, the flight route for changing the traveling direction and speed of the flying object determined to have a possibility of collision.

(18)

An information processing method, using an information processing device, including

setting an avoidance trajectory on which a flying object is able to avoid a collision with an obstacle on the basis of position information of the flying object and wind speed information of a flight position represented by the position information.

(19)

A program for causing a computer to execute processing of setting an avoidance trajectory on which a flying object is able to avoid a collision with an obstacle on the basis of position information of the flying object and wind speed information of a flight position represented by the position information.

### REFERENCE SIGNS LIST

10 Drone
20 Air traffic control device
41 Information acquisition unit
42 Communication control unit
43 Flight plan storage unit
44 Flight control unit
71 Communication control unit
72 Course prediction unit
73 Possible presence area calculation unit
74 Obstacle map storage unit
75 Three-dimensional map generation/update unit
76 Collision determination unit
77 Avoidance trajectory setting unit
211 Information acquisition unit
212 Course prediction unit
213 Possible presence area calculation unit
214 Obstacle map storage unit
215 Three-dimensional map generation/update unit
216 Collision determination unit
217 Avoidance trajectory setting unit
218 Flight plan storage unit
219 Flight control unit

1. An information processing device comprising an avoidance trajectory setting unit configured to set an avoidance trajectory on which a flying object is able to avoid a collision with an obstacle on the basis of position information of the flying object and wind speed information of a flight position represented by the position information.

2. The information processing device according to claim 1, further including a communication control unit configured to transmit an avoidance instruction based on the set avoidance trajectory to the flying object.

3. The information processing device according to claim 2, wherein the avoidance trajectory setting unit sets avoidance trajectories for a plurality of flying objects on the basis of the position information and the wind speed information of the plurality of the flying objects, and
wherein the communication control unit transmits avoidance instructions based on the avoidance trajectories set for the plurality of the flying objects to the respective plurality of flying objects.

4. The information processing device according to claim 3, wherein the avoidance trajectory setting unit sets the avoidance trajectory on which a first flying object is able to avoid collisions with an obstacle and a second flying object.

5. The information processing device according to claim 2, wherein the communication control unit receives at least the position information of the position information and the wind speed information from the flying object.

6. The information processing device according to claim 5, wherein the communication control unit receives the position information and the wind speed information acquired by the flying object from the flying object.

7. The information processing device according to claim 5, wherein the communication control unit receives, from a predetermined device, the wind speed information of the flight position represented by the position information acquired by the flying object.

8. The information processing device according to claim 1, further comprising an information acquisition unit configured to acquire the position information and the wind speed information, and
a flight control unit configured to control flight of the flying object on the basis of the set avoidance trajectory.

9. The information processing device according to claim 1, further comprising a collision determination unit configured to determine presence or absence of a collision with the obstacle on the basis of the position information and the wind speed information,
wherein the avoidance trajectory setting unit sets the avoidance trajectory when it is determined that there is a possibility of collision.

10. The information processing device according to claim 9, further comprising an area calculation unit configured to calculate a possible presence area of the flying object after a predetermined time on the basis of a predicted position of the flying object after a predetermined time predicted using the position information and the wind speed information,
wherein the collision determination unit determines presence or absence of the possibility of collision after the predetermined time on the basis of the possible presence area.

11. The information processing device according to claim 10, wherein the area calculation unit calculates the possible presence area by transforming an area based on the predicted position according to a direction and a magnitude of a wind speed represented by the wind speed information.

12. The information processing device according to claim 11, wherein the area calculation unit transforms a circular area having the predicted position as a center according to the direction and the magnitude of the wind speed represented by the wind speed information.

13. The information processing device according to claim 10, wherein the area calculation unit calculates possible presence areas of the plurality of the flying objects on the basis of predicted positions of the plurality of the flying objects and the wind speed information, and
the collision determination unit further determines presence or absence of the possibility of collision between the flying objects on the basis of the possible presence areas of the plurality of the flying objects.

14. The information processing device according to claim 10, further comprising a map generation unit configured to generate a three-dimensional map that maps the possible presence area on an obstacle map including three-dimensional position information of the obstacle,
wherein the collision determination unit determines presence or absence of the possibility of collision after the predetermined time on the basis of the three-dimensional map.

15. The information processing device according to claim 14, wherein the area calculation unit recalculates the possible presence area on the basis of the set avoidance trajectory, and
the map generation unit updates the three-dimensional map on the basis of the recalculated possible presence area.

16. The information processing device according to claim 9, wherein the avoidance trajectory setting unit sets, as the avoidance trajectory, a flight route for changing at least a traveling direction of the flying object determined to have a possibility of collision.

17. The information processing device according to claim 16, wherein the avoidance trajectory setting unit sets, as the avoidance trajectory, the flight route for changing the traveling direction and speed of the flying object determined to have a possibility of collision.

18. An information processing method, using an information processing device, comprising
setting an avoidance trajectory on which a flying object is able to avoid a collision with an obstacle on the basis of position information of the flying object and wind speed information of a flight position represented by the position information.

19. A program for causing a computer to execute processing of
setting an avoidance trajectory on which a flying object is able to avoid a collision with an obstacle on the basis of position information of the flying object and wind speed information of a flight position represented by the position information.
